(19) United States
(12) Patent Application Publication
(10) Pub. No.: US 2025/0156506 A1
(43) Pub. Date: May 15, 2025

(54) METHOD OF MINTING AND USING VEHICLE-RELATED NON-FUNGIBLE TOKENS, AND INFORMATION TECHNOLOGY SYSTEM

(71) Applicant: MERCEDES-BENZ GROUP AG, Stuttgart (DE)

(72) Inventors: Viktor FRIESEN, Karlsruhe (DE); Micha KOLLER, Fellbach (DE); Hubert REHBORN, Sindelfingen (DE)

(21) Appl. No.: 18/840,229

(22) PCT Filed: Jan. 20, 2023
(86) PCT No.: PCT/EP2023/051386

§ 371 Date: Aug. 21, 2024

(30) Foreign Application Priority Data
Feb. 22, 2022 (DE) 10 2022 000 646.4

(51) Int. Cl. G06F 21/10; G06Q 20/06; G06Q 20/36

(52) U.S. Cl. CPC G06F 21/1014; G06Q 20/06; G06Q 20/36

(57) ABSTRACT

An information technology system mints at least one non-fungible token that is assigned to a vehicle and includes at least one proof of ownership, usage rights, and/or properties of the vehicle. At least one vehicle-internal detection device detects vehicle-related raw data and a vehicle-internal and/or a vehicle-external collecting device stores at least a sub-quantity of the raw data. A vehicle-internal and/or a vehicle-external aggregating device prepares at least a sub-quantity of stored raw data and a vehicle-internal converting device converts prepared data into NFT input data. A vehicle-internal transmitting device transmits the NFT input data to a vehicle-external minting device, which mints one of the non-fungible tokens using the NFT input data in an unmodified form.

### BACKGROUND AND SUMMARY OF THE INVENTION

Exemplary embodiments of the invention relate to a method of minting and using vehicle-related non-fungible tokens and to an information technology system for carrying out the method.

Certain digital currencies, or the respective blockchain that is the basis of the digital currency, such as Ethereum blockchain, Binance smart chain, or Solana, allow so-called non-fungible tokens (NFT) to be generated, which is also referred to in the following as minting. An NFT is an irreplaceable digital object. To mint the NFT, information relevant to the NFT, in the form of information blocks, is integrated into the blockchain of the digital currency that is the basis of the respective NFT. Using NFTs, files that can usually be easily digitally copied, such as a computer-generated artwork, are characterized as a unique pieces, and their ownership is signed over to a particular stakeholder by selling the NFT.

To avoid disproportionately large quantities of data being stored in the blockchain, an information block integrated into the blockchain can also comprise a link to a blockchain-external resource. The owner and all properties of an NFT are publicly visible. The properties of the NFT can no longer be changed after minting.

As acceptance of “cryptocurrencies” increases, the popularity of NFTs is also increasing. Thus, for example, the U.S. Pat. Nos. 10,505,726 B1 and 11,113,754 B2 of the firm Nike Inc. disclose methods suitable for everyday use for using NFTs in connection with commercially available physical goods. The methods describe the generation of an NFT that is representative of an individual retail item such as a sports shoe when the individual retail item is bought by a person. The corresponding person comprises a unique user ID, which is assigned to the corresponding NFT. The buyer of the individual retail item thus receives a unique digital proof of the acquisition of the individual retail item. Properties of the individual retail item, for example a color, a material, a manufacturer, a model name, a size, or the like can be included in the generation of a respective NFT. The buyer of the individual retail item can sell the NFT assigned to the individual retail item on to a third party. They need not necessarily give the physical individual retail item or a digital depiction thereof to the third party. The methods additionally describe using a digital depiction of the physical individual retail item in a video game, generating combined digital depictions of individual retail items by mixing the properties of two parent individual retail items and obtaining digital depictions and corresponding NFTs of a sports shoe at an event.

In addition, US 2020/311698 A1 discloses the generation of an NFT for a vehicle by the vehicle. For this purpose, the vehicle comprises a computer, which is able to read vehicle data collected by the vehicle. The computer forms a node of a proof-of-stake network for calculating a blockchain. The computer itself causes the NFT to be minted. The level of wear of the vehicle can be described by means of the NFT, and thus a residual value of the vehicle, for example in the form of monetary units, can be kept track of in a decentralized manner.

In addition, DE 10 2018 115347 A1 discloses methods and means of generating and managing a digital vehicle registration certificate, on the basis of blockchain technology.

The Ethereum framework is additionally described in detail in: Antonopoulos Andreas M ET AL: “Mastering Ethereum”, Mastering Ethereum: Building Smart Contracts and DApps, 1 Jan. 2018 (2018 Jan. 1), XP055880605, ISBN: 978-1-4919-7194-9.

DE 10 2013 003063 A1 further discloses the control of the communication behavior of a motor vehicle. The motor vehicle is able to exchange messages with vehicle-external devices by means of a mobile device. The frequency with which messages are exchanged, the resultant quantity of data and/or the respective message type can be configured in the device. The respective configuration is stored in the form of a configuration data set. Different configuration data sets can be loaded as required by a central control unit, and thus the communication behavior of the mobile device can be adjusted.

Exemplary embodiments of the present invention are directed to a particularly secure and more reliable method and information technology system for minting and using vehicle-related non-fungible tokens, using which user convenience can be increased for vehicle owners.

In a generic method of minting and using vehicle-related non-fungible tokens NFT, an information technology system mints at least one NFT assigned to a vehicle, the NFT comprising at least a proof of ownership, usage rights, and/or properties of the vehicle, wherein at least one vehicle-internal recording device records vehicle-related raw data, a vehicle-internal, and/or a vehicle-external collection device stores at least a sub-set of the raw data, and wherein at least a sub-set of stored raw data is prepared, prepared data is converted into NFT input data, and an NFT is minted incorporating the NFT input data. Such a conventional method is developed according to the invention such that a vehicle-internal and/or a vehicle-external aggregation device prepares at least a sub-set of stored raw data to generate prepared data, a vehicle-internal conversion device converts prepared data into NFT input data, a vehicle-internal transmission device transmits the NFT input data to a vehicle-external minting device, which mints one of the NFTs incorporating the NFT input data in an unchanged form.

Using the method according to the invention, NFTs can be minted for vehicles, the NFTs can be enriched with information relevant to the respective vehicles and can be assigned to the corresponding vehicles, or to a corresponding vehicle user. This makes it possible to provide completely new services for the customers of a vehicle manufacturer, whereby customer satisfaction and user convenience can be increased. Unlike a sports shoe, painting, film, piece of music or the like, for example, a vehicle itself is an information technology system or part of a larger information technology system, which is involved in the minting of an NFT relating to itself.

Thus, when minting object-related NFTs, attempted fraud increases. For example, a scammer can pretend to be a famous artist, and mint and sell an NFT of an artwork, although the scammer is not actually the producer or owner of the artwork. Similar problems also arise when generating NFTs for individual retail items. Thus, for example, a scammer could carry out the necessary steps to mint an NFT assigned to a respective individual retail item, i.e., scanning an identification tag or taking a photo on location in a store, but then not buy the individual retail item. Because the object for which a respective NFT should be generated is actively involved in generating the NFT, however, such attempted fraud can be reliably prevented.

Vehicle-related raw data is recorded using the vehicle-internal recording device. The recording device can be a sensor, and the raw data can be measured values of the respective sensor. The recording device can also be a system having read access to a data bus and/or a physical storage medium, and that reads corresponding data transmitted via the bus and/or stored in the storage medium. The vehicle can have one or more recording devices. The respective recording devices can sit at any location in the vehicle and can be integrated or distributed into one or more vehicle subsystems that are independent of each other. Raw data generated by the recording device or recording devices is then stored by one or more collection devices. A collection device can store raw data from one or more recording devices. Sub-sets of the raw data that are no longer required can also be discarded to reduce storage requirements. Depending on what kind of NFT should be minted, the raw data required for this purpose is transmitted from the collection device to an aggregation device and prepared there. Preparing the raw data can, for example, comprise conversion into a particular file format, compressing a file size, sorting, filtering, integration, or other data processing of the raw data.

Recording and storing data can be subject to various data protection restrictions. By preparing the raw data, the raw data can be manipulated such that applicable data protection guidelines are fulfilled. The raw data is preferably stored as briefly as possible for this purpose.

The conversion device then collects the prepared data generated by all the aggregation devices and generates NFT input data therefrom, which is in turn transmitted to the vehicle-external minting device via the transmission device. The transmission of the NFT input data to the minting device can be implemented in a wired manner, or preferably also wirelessly. For this purpose, proven transmission techniques, e.g., mobile communication, Wi-Fi, Bluetooth, NFC or the like can be used. The data collection, caching and transmission is preferably implemented such that it is secured via cryptographic authentication and encryption measures.

The vehicle-external minting device is a computer system that is able to generate new NFTs, and thus to integrate data blocks enriched with information into the blockchain that is the basis of a cryptocurrency. The NFT input data is integrated into the minting process of the NFT in an unaltered form. This means that the NFT input data is integrated one to one into a corresponding information block of the blockchain. If, for example, a vehicle identification number is a component of the NFT input data, then the corresponding vehicle identification number is integrated into a corresponding NFT as plain text. If data sets are too large, for example in an image, a corresponding link to an online database in which the corresponding image is deposited can also be integrated into the NFT.

In comparison with direct integration of vehicle-related information and/or supply chain-related information into a blockchain, the use of NFTs to document an authenticity and/or origin of a product allows a particularly flexible design of a subsequent use of the information stored in the blockchain (as an NFT).

An advantageous development of the method provides that at least one vehicle-external recording device is incorporated into the process for generating prepared data. The vehicle-external recording device and the vehicle-external collection device and/or aggregation device can be an integral component of a central computer, for example of a cloud server or server network. Such a cloud server can, for example, be operated by a vehicle manufacturer and be used to manage vehicle fleet information. This makes it possible to record information associated with managing vehicle fleets. In addition, extensive data can be recorded, which is only available to the vehicle manufacturer, for example information that arises during the production of the vehicles. The individual recording devices, collection devices and/or aggregation devices can thus be integrated at any location into vehicles, vehicle subsystems, a cloud server, server network, or components thereof, and into mobile devices. However, at least one vehicle-internal recording device is involved in creating the prepared data in order to provide the conversion device with at least one piece of information representative of the respective vehicle, such as a vehicle identification number, a cryptographic private key of the vehicle or another identifier. In the simplest case, the vehicle-internal recording device can thus be a device for reading a piece of digital information from a data storage device. The NFT input data is generated by a respective vehicle-internal conversion device, and is transmitted from a respective vehicle, to which the NFT should apply, to the vehicle-external minting device.

In a vehicle-external recording device, vehicle-external recorded raw data can also be transmitted to individual vehicles for further processing. Similarly, vehicle-internal recorded raw data can also be transmitted to the central computer and further processed there. The vehicle-externally generated prepared data is then transmitted back to a respective vehicle, however, for conversion into the NFT input data. This ensures that scammers cannot generate NFTs assigned to the corresponding vehicle.

Corresponding to a further advantageous embodiment of the method, at least two separate vehicle subsystems respectively have their own aggregation device, wherein raw data recorded in a respective vehicle subsystem is prepared by the respective aggregation device of the vehicle subsystem. It is thus ensured that no raw data can leave a respective vehicle subsystem. Locally occurring data thus remains in a respective subsystem of the vehicle. Local data preparation has two advantages. On the one hand, the transmission of disproportionately large data sets is prevented because prepared data requires less installation space than the raw data itself. As a rule, the raw data is comparatively comprehensive, and thus particularly critical from a data protection standpoint. If the raw data leaves a respective subsystem in which it was created, however, there can also be no threat of breaches of data protection.

A further advantageous embodiment of the method furthermore provides that prepared data is temporarily cached in the aggregation device, before the prepared data is transmitted to the conversion device. In general, it is possible for a respective aggregation device to prepare the raw data immediately before transmission to the conversion device. However, a comparatively large amount of raw data must thus be stored by a respective aggregation device. However, the aggregation device can also prepare the raw data once or more than once while the raw data is recorded before the prepared data is transmitted to the conversion device, and cache the prepared data. This makes it possible to discard raw data that is no longer needed and/or prepared data that is no longer required, and correspondingly to save storage space.

Corresponding to a further advantageous embodiment of the method, a configuration data set is generated by means of a configuration device, the configuration data set comprising a configuration for a respective recording device, collection device, aggregation device, conversion device and/or transmission device, which is read by a respective device in order to control the behavior of the respective device to mint a particular NFT. Depending on the intended use or type of the NFT to be generated, it is necessary to collect and process particular vehicle-related raw data. By means of the configuration data set, the corresponding devices can then be parameterized such that the information required to generate, and thus to mint the desired NFT is obtained. Depending on the intended use and the NFT to be generated, it is not strictly necessary to reconfigure each of the devices to generate a new NFT.

The configuration device can be designed to be inside the vehicle or outside the vehicle. The configuration device is, for example, operated by a user such as a vehicle keeper, vehicle owner, vehicle vendor, the vehicle manufacturer, or the like. A vehicle-internal human-machine interface, such as the infotainment system of the vehicle or a web application, can, for example, be used to operate the configuration device. A corresponding web application can, for example, be operated via a browser run on a computer or by an application (app) run on a smartphone. The operation of the configuration device can be designed to differ in complexity depending on an authorization level of a user and/or their expertise. The configuration device can thus be designed to be particularly easy to operate for an unauthorized layperson, and a large number of configuration possibilities can be offered to an authorized expert. For example, the layperson can operate the configuration device via an operating display, and the expert can program the respective devices themselves, including the definition of parameter values and constants.

A further advantageous embodiment of the method according to the invention further provides that a configuration data set comprises at least one of the following pieces of information:
a definition of the NFT input data to be generated;
a definition of circumstances when an NFT should be minted;
a definition of the raw data to be recorded;
a definition of an aggregation function used by an aggregation device to prepare the raw data; and/or
a definition of a conversion function used by the conversion device to convert the prepared data into NFT input data.

A decision of which NFTs should be generated can follow a top-down or bottom-up approach. The top-down approach provides that a user specifies which desired NFTs should be generated. The configuration device then decides independently which raw data needs to be recorded to generate the respective NFT and how this data needs to be further processed. On the other hand, the bottom-up approach provides that a user shares with the configuration device which raw data should be recorded during vehicle use, and how it should be further processed. It is then possible to mint different NFTs depending on the settings made.

Corresponding to a further advantageous embodiment of the method, a pre-defined configuration data set is generated from a list of pre-defined configuration data sets by the configuration device, and is read by the devices. This makes it possible for a lay user to operate the configuration device particularly intuitively and easily using a corresponding input display. Thus, for example, the layperson selects the desired NFTs to be minted, whereupon the configuration device loads the corresponding pre-defined configuration data sets, such that the recording device, collection device, aggregation device, conversion device and transmission device enable the corresponding desired NFTs to be minted.

For a recording device, a configuration data set can, for example, determine in which system the recording device should be executed (for example in the vehicle, on a cloud server, in a particular control device or the like), a type and a quantity of raw data to be recorded and under what conditions and/or at what points in time the respective raw data should be recorded and to which collection device(s) the raw data should be transmitted.

For a collection device, a configuration data set can, for example, determine in which system the collection device should be executed, by which recording devices information should be received, which type and what quantity of raw data should be received by a respective recording device, and under what conditions raw data should be stored or discarded, a respective aggregation device, to which stored raw data should be transmitted and under what conditions and/or at what points in time which information should be transmitted to a respective aggregation device.

For an aggregation device, a configuration data set can, for example, determine in which system the aggregation device should be executed, by which collection devices raw data should be received, in which case a type of raw data and a raw data quantity to be processed can also be defined, an aggregation function to be used to prepare the raw data and the precise behavior of a respective aggregation function. These include, for example, the quantity of raw data on which a respective aggregation function depends, a calculation rule specifying how prepared data should be generated from raw data, a set of points in time, and/or conditions that determine when a respective aggregation function should be executed and when which raw data can be deleted after it has been used.

For a conversion device, a configuration data set can, for example, determine in which system the conversion device should be executed, by which aggregation devices prepared data should be received, according to which conversion function NFT input data should be generated from prepared data and/or a set of events and/or conditions at which points in time the minting of an NFT should be prompted.

For a transmission device, a configuration data set can for example determine to which minting device the NFT input data to be used to mint an NFT should be transmitted.

A further advantageous embodiment of the method further provides that a user manually initiates the minting of one of the NFTs, or a request to confirm the minting of the NFT is made to the user before one of the NFTs is automatically minted. In other words, the user is required to input a manual control action before a vehicle-related NFT is minted. The user is thus given full control to prevent the undesirable minting of NFTs for their vehicle. Because a blockchain is generally publicly visible, the user can thus prevent a third party from being able to read the information connected to the NFT input data from the blockchain if they do not want them to. A user can also want particular NFTs to be minted, but want to avoid the publication of particular information in the form of NFT input data in the blockchain. The user can thus initiate or allow the minting of the NFT they want, and avoid the minting of NFTs that the user does not want.

Corresponding to a further advantageous embodiment of the method, a private key, using which a transaction of one of the NFTs to a third-party can be prompted, is stored in a vehicle-internal hardware wallet and/or in a wallet to which there is access from the vehicle. Thus, the vehicle is not only integrated into the creation or minting of the NFT as an information technology system, but the use of the NFT from the vehicle is also enabled. NFTs can be accessed particularly conveniently by means of a vehicle-integrated hardware wallet. The private key required to prompt transactions is then stored in this hardware wallet. However, a computer of the vehicle can also be in communication with the server of a service provider, for example via a telematics unit, said service provider administering a user account to which the corresponding NFTs are assigned. The computer of the vehicle can for example also be communicatively connected to a mobile device which comprises a corresponding hardware wallet.

A user may be required to authenticate themselves to make transactions. For this purpose, usual authentication methods, such as inputting passwords, reading biometric distinguishing features, scanning codes or the like can be used.

A further advantageous embodiment of the method furthermore provides that the properties that can be configured to produce a vehicle are included in one of the NFTs, and for a vehicle having a unique property combination, the minting of a further NFT corresponding to the unique property combination and/or the production of a further vehicle corresponding to the unique property combination is prevented. The properties of a vehicle, for example, include the vehicle motorization, the selected chassis, the selected special equipment, the selected vehicle paint, and the like. There is a possibility that the buyer of a vehicle has made a unique vehicle configuration. If this is the case, then the buyer can determine that no further vehicles having the same properties, i.e., having the unique combination of properties, are produced by the vehicle manufacturer. It is also possible that the production of such vehicles remains possible, but no further NFTs can be generated for such a vehicle except by the owner of the first vehicle having the unique combination of properties. A particular user experience is thus enabled for the buyer of the vehicle because there can be no other owner of such a vehicle or of an NFT assigned to such a vehicle. Of course, the buyer of the vehicle having the unique combination of properties can sell on the NFTs they own.

Preferably, when at least one of the following circumstances arises, an NFT is minted:
the vehicle is produced;
the vehicle is sold;
the vehicle undergoes repair or maintenance;
the vehicle stops at a fixed location;
a fixed point in time is reached, or a fixed duration of time passes;
the vehicle covers a fixed distance;
a particular vehicle function is present or absent; and/or
a vehicle performance is exceeded or fallen short of in comparison to a respective vehicle performance of the vehicles of a vehicle fleet.

An NFT produced during manufacture of a vehicle can, for example, contain vehicle data, such as a vehicle identification number, a series, a model, a paint, a motorization, a piece of equipment, a production facility, a date and/or completion time, a serial number of the vehicle on the day/month/year, or the like.

An NFT can also be minted if the vehicle is sold or gifted, and thus a change of vehicle keeper takes place. The exact owner of the vehicle can thus be tracked with NFTs.

NFTs can also be minted if parts and/or components of the vehicle are repaired, undergo maintenance or are switched or manipulated in any way. This includes, for example, carrying out a software update or decommissioning/scrapping the vehicle. It can thus be ensured that only authorized repairs or maintenance work are carried out on the vehicle. For example, corresponding NFTs can only be generated by an authorized repair garage. Changes can naturally be carried out physically on the vehicle without minting new NFTs. If, however, the corresponding NFT for such a change is missing, then a corresponding vehicle keeper or potential buyer will know that an unauthorized manipulation of the vehicle has taken place.

It is also possible to mint NFTs if the vehicle stops in a particular location. Different methods can be used to record the stopping location of the vehicle, e.g., GPS position monitoring. For this purpose, the vehicle can comprise a corresponding navigation system or communicate with a mobile device such as a smartphone or a mobile navigation device. So-called “challenges” are known for video games. If particular achievements are reached in the video game, then a trophy is given to the player. This can also be applied to vehicles. For example, NFTs can be minted if particular countries or cities are travelled to with the vehicle. This can be an incentive for a vehicle user to travel more with their own vehicle, and improves their user experience with the vehicle. Further locations that can be associated with minting an NFT are for example visiting particular attractions, UNESCO world heritage sites, attending a particular sporting event, groundhopping, or the like.

NFTs can further be minted when a particular point in time is reached or a fixed period of time has elapsed. For example, an NFT can be minted when a particular time on a particular date is reached, it is the vehicle user's birthday, it is the anniversary of the vehicle being licensed or sold, a financing period has elapsed or the like.

NFTs can also be minted when a pre-determined distance has been covered with the vehicle, for example every 10,000 kilometers, 50,000 kilometers or 100,000 kilometers and/or a particular number or combination of events has arisen, such as visiting 10 UNESCO sites or visiting 100 stadiums while groundhopping. An NFT can also comprise a piece of information representative of a rarity, such as a bronze status, silver status, or gold status. Thus, for example, an NFT with silver status can be minted every 50,000 kilometers and an NFT with gold status can be minted every 100,000 kilometers. A differentiation can also be made between different drivers of the vehicle.

This can also be used to mint vehicle-related NFTs, taking into account further vehicle-related information. For example, an NFT can be minted if the driver X has not exceeded the permissible speed limit for example by more than 10 km/h in ten 10 years.

In general, NFTs can be minted if individual vehicle functions arise or are used or cease or are not used. For example, an NFT can be minted if the radio has been listened to in the vehicle for 1000 hours, if a back seat of the vehicle has never been used, a million wiping processes have been carried out with the windscreen wiper of the vehicle, the fog lights of the vehicle have never been used, or the like. By minting such NFTs, the state of the vehicle can also be evaluated, which can also be relevant to price negotiations when selling the vehicle on. For example, in a vehicle with an automatic transmission, the number of kickdowns carried out can be counted, and for example an NFT can be minted every one thousand kickdowns. The more such NFTs have been minted for the vehicle, the more wear it has.

NFTs minted for a particular vehicle can be compared with the NFTs minted for other vehicles. A competition, a so-called challenge, can thus be held. For example, an NFT can be minted for the vehicle of a vehicle fleet that has covered the greatest distance in a particular year, has been operated most efficiently, has covered the most passenger kilometers, has driven the fastest, was in traffic the longest, has the longest usage duration, has the most NFTs with gold status, or the like. For example, it can also be counted which number user is using a particular vehicle function, for example the thousandth user of live traffic.

By holding such challenges, interest of customers in the vehicle is increased, and a particularly exciting user experience is generated.

According to the invention, in an information technology system with a vehicle, a central computer and a minting device, the vehicle, the central computer and the minting device are equipped to carry out a method described above. The vehicle can comprise one or more computers that are actively involved in minting the NFT. These include the recording device, collection device, aggregation device, conversion device, and transmission device, wherein the vehicle has at least one internal recording device, conversion device, and transmission device. One or more recording devices, collection devices, and/or aggregation devices can also be provided vehicle-externally in the central computer. A configuration device for configuring the respective devices can be designed vehicle-internally or vehicle-externally. The minting device can also be part of the central computer or be operated by a third party. For example, the minting device is a component of a distributed infrastructure used to administer a blockchain operated by means of distributed ledger technology. The individual components of the information technology system can exchange data with one another via various proven communication paths.

An advantageous development of the information technology system comprises a mobile device that is coupled directly or indirectly to the vehicle via the central computer, wherein a vehicle-external recording device, collection device and/or aggregation device is executed on the mobile device. The mobile device is, for example, a smartphone, tablet computer, laptop, a wearable such as a smartwatch or the like. A coupling between the vehicle and the mobile device can be implemented in a wired manner, for example by means of a USB cable, and/or wirelessly, for example by means of Wi-Fi, Bluetooth, NFC or the like. A piece of software or application can run on the mobile device, the piece of software or application providing the corresponding functionality of a recording device, collection device and/or aggregation device via the mobile device. The information technology system can thus be expanded particularly easily and flexibly.

Further advantageous embodiments of the method according to the invention for minting and using vehicle-related non-fungible tokens and of the information technology system used for this purpose result from the exemplary embodiments, which are described in more detail in the following with reference to the figures.

### BRIEF DESCRIPTION OF THE DRAWING FIGURES

Here:

FIG. 1 shows a schematic depiction of an information technology system according to the invention used to mint non-fungible tokens; and

FIG. 2 shows a schematic process diagram of a process flow according to the invention for minting a non-fungible token.

### DETAILED DESCRIPTION

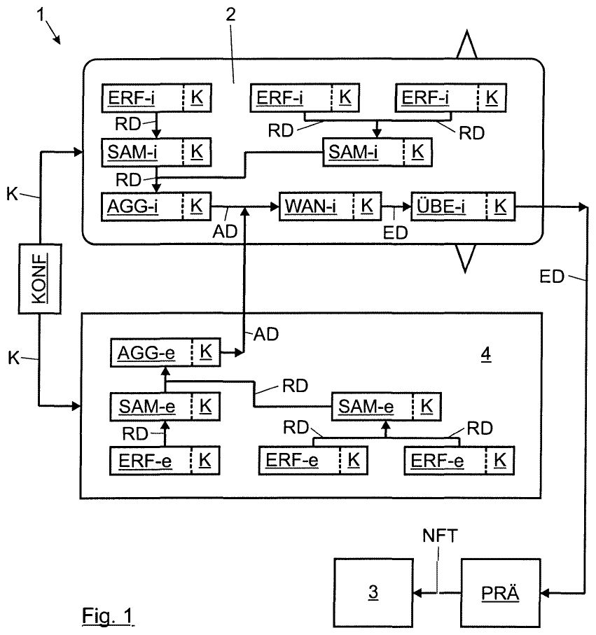

FIG. 1 shows, in a schematic depiction, an information technology system 1 according to the invention, comprising a vehicle 2, a central computer 4, a configuration device KONF, a minting device PRÄ, and a wallet 3 for keeping non-fungible tokens NFT. A non-fungible token NFT is not kept directly in the wallet 3, however, and is instead stored as an information block in a blockchain administered in a decentralized manner. The information block contains an identifier of a user account assigned to a user. This identifier is typically formed by a public key. In order to transfer a non-fungible token NFT, the identifier of a new user is then written in the information block of the non-fungible token NFT. For authenticated authorization of this method, a private key of the original owner is required. This private key is kept in the wallet 3.

It is possible to mint and use vehicle-related non-fungible tokens NFT using the information technology system 1. Such a non-fungible token NFT, for example, comprises a proof of ownership, usage rights, and/or properties of the vehicle 2. The vehicle 2 with its internal systems and computers (not depicted in more detail) is part of the information technology system 1 and involved in minting the non-fungible token NFT. Vehicle-related data is thus received from the vehicle 2, the data being used to mint the non-fungible token NFT.

In order to record relevant data, for example sensor values or data read via a bus system of the vehicle 2, one or more computers of the vehicle 2 comprise a recording device ERF-i. The recording device ERF-i reads corresponding sensor data and/or vehicle busses and generates raw data RD from them. The raw data RD is transmitted to a collection device SAM-i for storage. A collection device SAM-i of several recording devices ERF-i can also contain raw data RD.

In the following, the stored raw data RD is transmitted to an aggregation device AGG-i for preparation. Here too, an aggregation device AGG-i of one or more collection devices SAM-i can receive raw data RD. In the exemplary embodiment in FIG. 1, only one aggregation device AGG-i is depicted for the vehicle 2. However, the vehicle 2 can also contain several aggregation devices AGG-i.

After a successful transmission of the raw data RD to the aggregation device AGG-i, the corresponding raw data RD can be deleted from the collection devices SAM-i. In order to prepare the raw data RD to generate prepared data AD, the raw data RD is, for example, filtered, brought to a unified file format, sorted, irrelevant data is discarded, integrated or further digitally processed in another way.

The prepared data AD is then transmitted to a conversion device WAN-i, and converted by the latter into NFT input data ED. The NFT input data ED has a corresponding file format required to mint non-fungible tokens NFT, and comprises the information to be integrated into a non-fungible token NFT. The minting device PRÄ can then read the NFT input data ED and mint it in an unchanged form to make a non-fungible token NFT. For this purpose, corresponding information blocks are integrated by the minting device PRÄ into the blockchain administered by a distributed infrastructure. In order to transmit the NFT input data ED from the vehicle 2 to the minting device PRA, the vehicle 2 transmits the NFT input data ED by means of a transmission device ÜBE-i. For example, the NFT input data ED can be transmitted to a cloud server via mobile communications, the cloud server then transmitting the NFT input data ED to the distributed infrastructure used to administer the blockchain via the internet. The cloud server can itself also form a node of the distributed infrastructure. The central computer 4 can also form the cloud server or work as a node of the distributed infrastructure.

After the distributed infrastructure has processed the corresponding NFT input data ED and minted the non-fungible token NFT, the corresponding non-fungible token NFT is assigned to the user account that can be accessed by the private key stored in the wallet 3.

Depending on the information to be included in a non-fungible token NFT, data can also be accessed by the central computer 4, for example a cloud server or backend of a vehicle manufacturer. This allows information connected to administering a vehicle fleet to be integrated into a non-fungible token NFT. For this purpose, analogously to the vehicle 2, the central computer 4 comprises at least one recording device ERF-e, a collection device SAM-e, and an aggregation device AGG-e. The prepared data AD generated by the aggregation device AGG-e integrated into the central computer 4 is then transmitted to the vehicle 2 and fed into the conversion device WAN-i. By integrating the vehicle 2 into the minting process of a non-fungible token NFT that comprises data obtained from the central computer 4, it is ensured in a particularly reliable manner that an unauthorized minting of non-fungible tokens NFT that are valid for the vehicle 2 is prevented.

Depending on the desired non-fungible token NFT to be created, various data should be recorded by different devices for different periods of time. For this purpose, the individual devices, such as the recording device ERF-i, ERF-e, collection device SAM-i, SAM-e, aggregation device AGG-i, AGG-e, conversion device WAN-I, and transmission device ÜBE-i must be parameterized, i.e., configured. Such a configuration is implemented by means of a configuration data set K generated by the configuration device KONF. The configuration device KONF can be designed vehicle-internally, in the central computer 4, or external to these two devices, as depicted. The extent to which the individual devices of the information technology system 1 are configured by the configuration device KONF depends on the kind of non-fungible token NFT to be created and an authorization level of a user operating the configuration device KONF. A layperson can, for example, select pre-made configuration profiles from a list of pre-made configuration data sets. However, if this is desired or required, an expert will be able to undertake detailed adjustments on the individual devices down to a programming level.

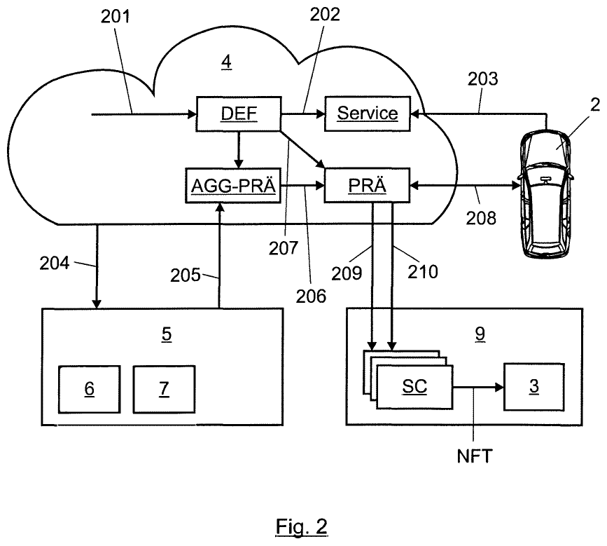

FIG. 2 shows a schematic process diagram of a process flow according to the invention for minting a non-fungible token NFT. In a method step 201 indicated by an arrow, an administrator of the central computer 4 defines which kinds of non-fungible tokens NFT can be issued. A definition data set DEF is generated from the latter, which comprises the NFT definitions including the configuration and settings of the individual devices.

In a method step 202, a list with the mintable non-fungible tokens NFT is generated from the definition data set DEF. This list is prepared for output to an NFT service Service.

In a method step 203, a user allows their vehicle 2 to participate in the NFT service Service and selects the desired non-fungible token NFT to be minted.

In a method step 204, data is transmitted for all vehicles 2 for which non-fungible tokens NFT are desired, the data telling the respective vehicles 2 which raw data RD needs to be collected to generate the corresponding non-fungible tokens NFT and how the data should be further processed. The corresponding information is obtained by a first distributed system 5 that comprises the vehicles 2 and the central computer 4. Mobile devices, e.g., a smartphone, can also be part of the first distributed system 5. The recording of the raw data RD is symbolized by a box 6, and the processing of the raw data RD to form NFT input data ED is symbolized by a box 7.

In the method step 205, the NFT input data ED is transmitted to the minting device PRÄ by means of the vehicle-internal transmission device ÜBE-i. In the exemplary embodiment in FIG. 2, the data is transmitted directly via a preparation device AGG-PRÄ integrated into the central computer 4. Several data sets of NFT input data ED can thus be combined by means of the preparation device AGG-PRÄ, and then transmitted to the minting device PRÄ in method step 206. The minting device PRÄ can also be part of a second distributed system 9, which administers the blockchain that is the basis of a corresponding non-fungible token NFT. In the method step 207, the minting device PRÄ is configured corresponding to the definition data set DEF.

In the method step 208, the vehicle 2 queries whether non-fungible tokens NFT can be received, or automatically emits a notification that non-fungible tokens NFT can be issued.

In the method step 209, non-fungible tokens NFT to be generated according to the NFT input data ED are finally minted by the minting device PRÄ by including corresponding information blocks in the respective underlying blockchain. For this purpose, intelligent contracts SC, also described as smart contracts, are signed. In the method step 210, the minting device PRA triggers the transfer of the minted non-fungible token NFT to the wallet 3 of the user.

Although the invention has been illustrated and described in detail by way of preferred embodiments, the invention is not limited by the examples disclosed, and other variations can be derived from these by the person skilled in the art without leaving the scope of the invention. It is therefore clear that there is a plurality of possible variations. It is also clear that embodiments stated by way of example are only really examples that are not to be seen as limiting the scope, application possibilities or configuration of the invention in any way. In fact, the preceding description and the description of the figures enable the person skilled in the art to implement the exemplary embodiments in concrete manner, wherein, with the knowledge of the disclosed inventive concept, the person skilled in the art is able to undertake various changes, for example, with regard to the functioning or arrangement of individual elements stated in an exemplary embodiment without leaving the scope of the invention, which is defined by the claims and their legal equivalents, such as further explanations in the description.

1-13. (canceled)

14. A method comprising:
recording, by at least one vehicle-internal recording device of a vehicle, vehicle-related raw data;
storing, by a vehicle-internal or a vehicle-external collection device, at least a subset of the recorded vehicle-related raw data,
preparing, by a vehicle-internal or a vehicle-external aggregation device, at least the subset of stored raw data as prepared data;
converting, by a vehicle-internal conversion device, the prepared data into non-fungible token (NFT) input data;
transmitting, by a vehicle-internal transmission device, the NFT input data to a vehicle-external minting device; and
minting, by the vehicle-external minting device, an NFT that incorporates the NFT input data in an unchanged form and comprises at least a proof of ownership, usage rights, or properties of the vehicle.

15. The method of claim 14, wherein at least one vehicle-external recording device is also involved in the preparing of the prepared data.

16. The method of claim 14, wherein the vehicle-internal aggregation device includes at least a first and second vehicle-internal aggregation device respectively preparing raw data recorded by separate first and second vehicle subsystems.

17. The method of claim 14, wherein the prepared data is temporarily cached in the vehicle-internal or vehicle-external aggregation device before the prepared data is transmitted to the vehicle-internal conversion device.

18. The method of claim 14, further comprising:
generating, by a configuration device, a configuration data set comprising a configuration for a respective one of the at least one vehicle-internal recording device, the vehicle-internal collection device, the vehicle-external collection device, the vehicle-internal external aggregation device, the vehicle-external aggregation device, the vehicle-internal conversion device, or the vehicle-internal transmission device,
wherein the configuration is read by a respective one of the at least one vehicle-internal recording device, the vehicle-internal collection device, the vehicle-external collection device, the vehicle-internal external aggregation device, the vehicle-external aggregation device, the vehicle-internal conversion device, and the vehicle-internal transmission device to control behavior of the respective device to mint a particular NFT.

19. The method of claim 18, wherein the generated a configuration data set comprises at least one of:
a definition of the NFT input data to be generated;
a definition of circumstances when the NFR should be minted;
a definition of the raw data to be recorded;
a definition of an aggregation function used by the vehicle-internal or vehicle-external aggregation device to prepare the raw data; or
a definition of a conversion function used by the conversion device to convert the prepared data into NFT input data.

20. The method of claim 18, wherein the configuration data set is a pre-defined configuration data set generated from a list of predefined configuration data sets by the configuration device, and is read by a respective one of the at least one vehicle-internal recording device, the vehicle-internal collection device, the vehicle-external collection device, the vehicle-internal external aggregation device, the vehicle-external aggregation device, the vehicle-internal conversion device, and the vehicle-internal transmission device.

21. The method of claim 14, wherein a user manually initiates the minting of the NFT or a request to confirm the minting of the NFT is made to the user before the NFT is automatically minted.

22. The method of claim 14, wherein a private key, using which a transaction of the NFT to a third-party can be prompted, is stored in a vehicle-internal hardware wallet or in a wallet to which there is access from the vehicle.

23. The method of claim 14, wherein
properties that can be configured to produce a vehicle are included in the NFT, and
for a vehicle having a unique combination of the properties, the minting of a further NFT corresponding to the unique property combination or a production of a further vehicle corresponding to the unique property combination is prevented.

24. The method of claim 14, wherein the minting of the NFT is performed in response to:
the vehicle being produced;
the vehicle being sold;
the vehicle undergoing repair or maintenance;
the vehicle stopping at a fixed location;
a fixed point in time is reached or a fixed duration of time passes;
the vehicle covers a fixed distance;
a particular vehicle function is present or absent in the vehicle; or
a vehicle performance by the vehicle is exceeded or fallen short of compared to a respective vehicle performance of vehicles of a vehicle fleet.

25. An information technology system, comprising:
a vehicle;
a central computer; and
a minting device,
wherein the vehicle includes at least one vehicle-internal recording device configured to record vehicle-related raw data,
wherein a vehicle-internal or a vehicle-external collection device is configured to store at least a subset of the recorded vehicle-related raw data,
wherein a vehicle-internal or a vehicle-external aggregation device is configured to prepare at least the subset of stored raw data as prepared data,
wherein a vehicle-internal conversion device is configured to convert the prepared data into non-fungible token input data,
wherein a vehicle-internal transmission device is configured to transmit the NFT input data to a vehicle-external minting device, and
wherein the vehicle-external minting device is configured to mint an NFT that incorporates the NFT input data in an unchanged form and comprises at least a proof of ownership, usage rights, or properties of the vehicle.

26. The information technology system of claim 25, further comprising:
a mobile device coupled directly or indirectly to the vehicle via the central computer, wherein the mobile device includes the vehicle-external recording device, the vehicle-external collection device, or the vehicle-external aggregation device.
